(19) United States
(12) Patent Application Publication
(10) Pub. No.: US 2007/0258196 A1
(43) Pub. Date: Nov. 8, 2007

(54) Flat panel television mounting assembly, and method

(75) Inventors: David Koskinen, Foral Park (CA); Wayne C. Doherty, Port Perry (CA)

Correspondence Address: Meroni & Meroni, P.C., P.O. Box 309, Barrington, IL, 60011, US

(73) Assignee: DESIGNER AV EQUIPMENT

(21) Appl. No.: 11/418,963

(22) Filed: May 5, 2006

(51) Int. Cl. G06F 1/16

(52) U.S. Cl. 361/681; 248/201

(57) ABSTRACT

A bracketing assembly enables television enthusiasts to mount a flat panel television adjacent a support wall. The bracketing assembly comprises two groove-engageable bracket members and two grooved bracket members. The groove-engageable members may be mounted to a support wall to form a bracketed support assembly and the grooved members may be mounted to a flat panel television to form a bracketed television assembly. The goove-engageable members cooperate with the grooved bracket members to mount the bracketed television assembly to the bracketed support assembly. The bracketed support assembly thus supports the bracketed television assembly by way of the groove-engageable and grooved bracket members.

### BACKGROUND OF THE INVENTION

1. Field of the Invention

The present invention generally relates to a bracketing assembly for mounting articles upon vertical support structures. More particularly, the present invention relates to a bracketing assembly and method for mounting flat panel televisions and the like to viewing walls.

2. Description of the Prior Art

Flat panel televisions incorporating use of (gas) plasma displays (GPD), liquid crystal displays (LCD), surface-conduction, electron-emitter displays (SED), and field emission displays (FED), continue to gain in popularity, due in part, to the relative reduction in thickness or bulk otherwise present with more traditional cathode ray tube (CRT) televisions. The traditional CRT television often require bulky and/or unwieldy support systems to support the apparatus in an elevated stated adjacent a wall or similar other (vertical) support structure. These CRT support systems are not effective at supporting flat panel type televisions and thus certain new support assemblies were sought to support the newly emerging flat panel televisions. Some of the more pertinent patent-related prior art disclosing means for supporting wall-mountable objects and the like is briefly described hereinafter.

U.S. Pat. No. 3,838,842 ('842 patent), which issued to McCracken, discloses a Support Structure for Wall Mounted Objects. The '842 patent teaches an apparatus for supporting wall mounted objects so that such objects are selectively adjustable in a horizontal plane. The apparatus includes a fixed portion mounted on a wall and at least one movable portion adjustably carried by said fixed portion.

U.S. Pat. No. 4,712,761 ('761 patent), which issued to Wassell, discloses a Picture Wall Hanging Assembly. The '761 patent teaches a picture frame corner bracket comprising a downwardly extending flange for parallel engagement with a trough that extends from an elongated wall mounting strip. The bracket includes an upper straight edge extending to a square upper corner that permit a self-alignment and accurate securement to each upper corner of a picture frame. The flange of the bracket is disposed parallel with the upper edge so that when the bracket is engaged with the wall strip, the picture frame will automatically assume the same alignment as the wall strip.

U.S. Pat. No. 5,086,916 ('916 patent), which issued to Gray, discloses a Combination Toothbrush Sterilization Container and Mounting Bracket. The '916 patent teaches a toothbrush sterilization container and mounting bracket for sterilizing toothbrushes. In relevant portion, the assembly comprises a uniquely configured mounting bracket for mounting the container to a wall.

U.S. Pat. No. 6,102,348 ('348 patent), which issued to O'Neill, discloses an Appliance Mounting Device. The '348 patent teaches a mounting device for securing an appliance such as a flat screen television to a support including a base that is mounted to the support and a frame that is adapted to releasably secure the appliance. The base and frame are connected together by arms which are rotatably connected to the frame and base by hinges which permit the appliance to be positioned in a number of horizontal positions with respect to the support. Vertical positioning of the appliance with respect to the support is accomplished by further including pivoting connectors on the frame to which the arms are attached.

U.S. Pat. No. 6,923,413 ('413 patent), which issued to Dozier, discloses a Mounting Device for a Flat Screen Display Panel. The '413 patent teaches a mount for attaching a flat screen display panel in which a wall bracket is attached to a support surface, a panel bracket is secured to a display panel, and the two brackets then cooperate to securely affix the display panel to the support surface while allowing subsequent lateral and pivotal adjustment.

United States Patent Application Publication No. US 2003/0201372, authored by Dozier, describes a mount for attaching a flat screen display panel is disclosed in which a wall bracket is attached to a support surface, a panel bracket is secured to a display panel, and the two brackets then cooperate to securely affix the display panel to the support surface while allowing subsequent lateral and pivotal adjustment.

United States Patent Application Publication No. US 2004/0232298, authored by Bremmon et al., teaches a mounting system for connecting a flat panel display to a fixed structure, such as a building wall or ceiling, or display structure, includes a plurality of fastening buttons and a corresponding display connecting portion having keyhole slots. Each keyhole slot has an access hole and a notch. The fastening buttons are seated in the keyhole slots to hold the flat panel display adjacent the display connecting portion of the mounting system. The button has a head portion, a base portion, and a throat portion, the base portion preferably having a beveled region so that the device is self-aligning or self-guiding. At least part of the display connecting member adjacent the access hole may be ramped.

United States Patent Application Publication No. US 2005/00877661, authored by Rabenius, teaches an apparatus and method for mounting a flat screen television on a vertically oriented surface. The apparatus includes a mounting assembly that attaches to the back of the television and is lifted and slidably inserted in position on a wall mount assembly. The mounting assembly adapts to different sized mounting screws, permits the orientation of the television to be adjusted to square the television with the ceiling, and permits the television to be tilted about horizontal and vertical axis.

United States Patent Application Publication No. 2005/0242254, authored by Dozier, teaches a mount for attaching a flat screen display panel is disclosed in which a wall bracket is attached to a support surface, a panel bracket is secured to a display panel, and the two brackets then cooperate to securely affix the display panel to the support surface while allowing subsequent lateral and pivotal adjustment.

United States Patent Application Publication No. US 2005/0253035, authored by Dozier, further teaches certain methods for attaching a flat screen display panel which is disclosed in which a wall bracket is attached to a support surface, a panel bracket is secured to a display panel, and the two brackets then cooperate to securely affix the display panel to the support surface while allowing subsequent lateral and pivotal adjustment.

It will be seen from an inspection of the foregoing as well as from a general consideration of the state of the art that the prior art does not teach a bracketing assembly comprising paired groups of bracket members, the first pair comprising planar member-receiving grooves and the second pair comprising planar groove-engaging members, which when cooperatively mated function to retain support structures fastened thereto in positioned placement relative to one another under the force of gravity. Thus, the prior art perceives a need for a bracketing assembly comprising paired groups of bracket members, the first pair comprising planar member-receiving grooves and the second pair comprising planar groove-engaging members, which when cooperatively mated function to weight-retain support structures fastened thereto in positioned placement relative to one another.

### SUMMARY OF THE INVENTION

It is an object of the present invention to provide a bracketing assembly primarily designed for mounting flat panel televisions to walls. The present invention discloses a television bracketing system for enabling (flat panel) television viewing adjacent a vertical support structure or wall, which bracketing system comprises, in combination, flat panel television and a bracket assembly. The flat panel television essentially comprises an anterior viewing surface and a posterior television support surface. The bracketing assembly preferably comprises two support-mountable, groove-engageable bracket members and two television-mountable, grooved bracket members. Each support-mountable bracket member comprises a planar support-mountable portion and a planar groove-engageable portion. The groove-engageable portions are angled from support-mountable portions, and each support-mountable bracket member thus comprises a substantially V-shaped transverse cross-section.

The support-mountable portions may be vertically juxtaposed adjacent the vertical support structure and mounted thereto in parallel relation to one another to form a bracketed support assembly. The groove-engageable portions are thus angled from the support-mountable portions at the inferior ends thereof and extend upwardly away from the vertical support structure thus forming an upper support plane and a lower support plane.

The television-mountable bracket members each preferably comprise a planar television-mountable portion, and two parallel planar support portions. The support portions are each preferably orthogonal to the television-mountable portion of each television-mountable bracket member, thus forming a substantially II-shaped transverse cross-section. Each support portion of the television-mountable bracket member preferably comprises first and second support grooves.

The television-mountable portions may thus be juxtaposed adjacent the television support surface and mounted thereto in parallel relation to one another to form a bracketed television assembly. The first support grooves are preferably coplanar with one another and the second support grooves are coplanar with one another and both sets of grooves are angled from the television-mountable portions extending away from the television support surface.

The bracketed television assembly may thus be vertically juxtaposed adjacent the bracketed support assembly so as to align the upper support plane with the coplanar first support grooves and further to align the lower support plane with the coplanar second support grooves. Thus, the upper support plane may be received in or mated with the first support grooves and the lower support plane may be received in or mated with the second support grooves simultaneously. The bracketed support assembly thus supports the bracketed television assembly by way of the groove-engageable portions and the first and second grooves, respectively. The contemplated television bracketing system thus enables flat panel television viewing adjacent the vertical support surface via the anterior viewing surface.

The support-mountable portions inherently have opposing first and second support ends, each of which preferably comprises certain end stop structure. The end stop structures or end stops extend outwardly from the support-mountable portions at the first and second support ends for preventing disengagement of the bracketed television assembly from the bracketed support assembly. In other words, it is contemplated that the end stops function to prevent the otherwise laterally slidable bracketed television assembly from sliding off the ends of the support-mountable bracket members.

The television-mountable bracket members inherently have opposing inferior and superior member ends. The first support grooves extend away the superior member ends and the upper support plane extends therethrough or extends in adjacency thereto. To further prevent displacement of the bracketed television assembly relative to the bracketed support assembly, it is contemplated that the bracketing system of the present invention may further comprise certain end-fastening means for securing the superior member ends to the groove-engageable portion of the upper support plane 24.

Other objects of the present invention, as well as particular features, elements, and advantages thereof, will be elucidated or become apparent from, the following description and the accompanying drawing figures.

### BRIEF DESCRIPTION OF THE DRAWINGS

Other features of our invention will become more evident from a consideration of the following brief descriptions of patent drawings:

FIG. 1 is perspective view of a preferred bracketing assembly of the present invention as mounted to the posterior portions of a flat panel television shown in phantom.

FIG. 2 is an enlarged perspective view of the preferred bracketing assembly of the present invention shown in FIG. 1.

FIG. 3 is a posterior view of a phantom flat panel television showing a first television-mountable bracket member mounted to the television support surface and a second television-mountable bracket member being mounted to the television support surface at a lateral distance from the first television-mountable bracket member.

FIG. 3(a) is an enlarged top view of the first television-mountable bracket member shown in FIG. 3 with parts broken away to show certain bracket mounting means.

FIG. 4 is a top view of a phantom flat panel television showing first and second television-mountable bracket members mounted to the television support surface.

FIG. 4(a) is an enlarged top view of the first television-mountable bracket member shown in FIGS. 3 and 4 with parts broken away to show certain bracket mounting means.

FIG. 5 is a fragmentary anterior view of a phantom wall showing support studs in hidden broken lines and first and second support-mountable bracket members mounted to the wall in vertically spaced relation to one another.

FIG. 5(a) is a cross-sectional view of the second support-mountable bracket member shown FIG. 5 as mounted to the wall via certain bracket mounting means.

FIG. 6 is a fragmentary side view of a wall showing a first superior support-mountable bracket member mounted to the wall and a second inferior support-mountable bracket member being mounted to the wall at a longitudinal distance from the first support-mountable bracket member.

FIG. 7 is an enlarged fragmentary perspective view of a superior member end of a television-mountable bracket member mated with a first superior support-mountable bracket member via a support groove of the television-mountable bracket member and a groove-engageable portion of the superior support-mountable bracket member.

### DETAILED DESCRIPTION OF THE PREFERRED EMBODIMENT(S)

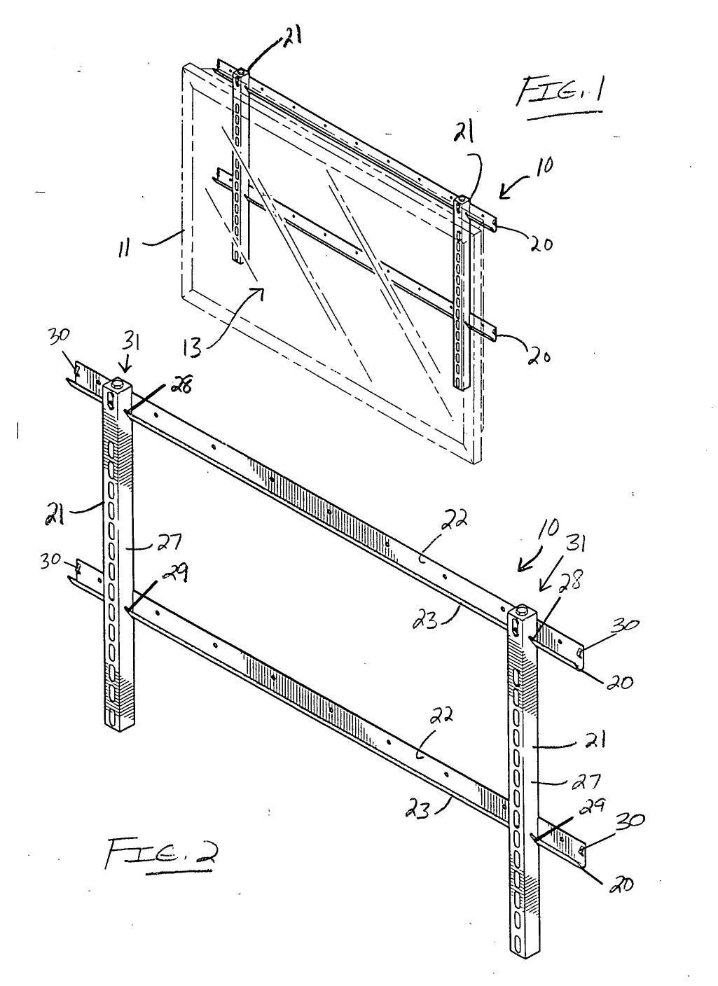

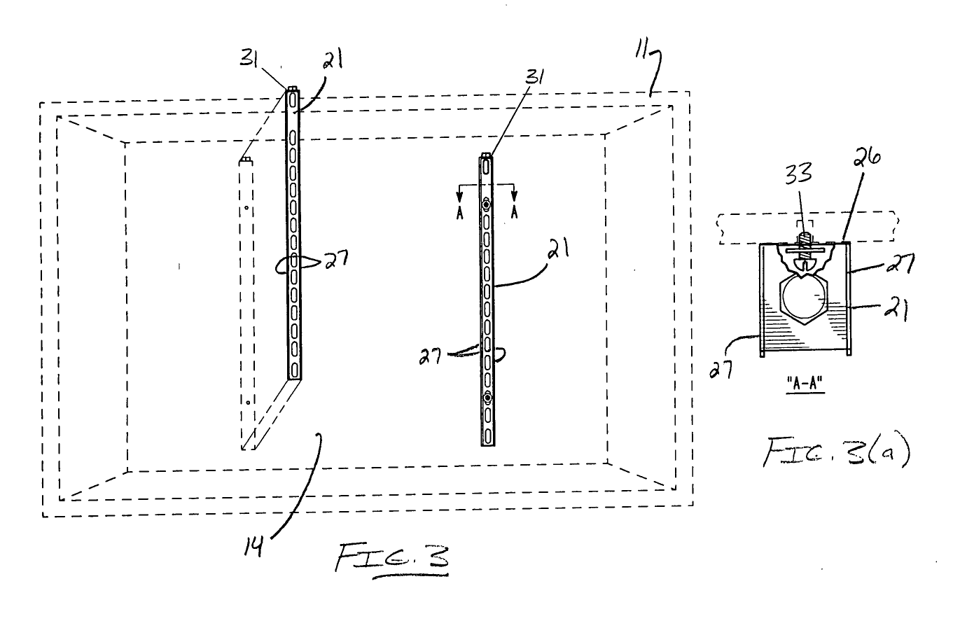

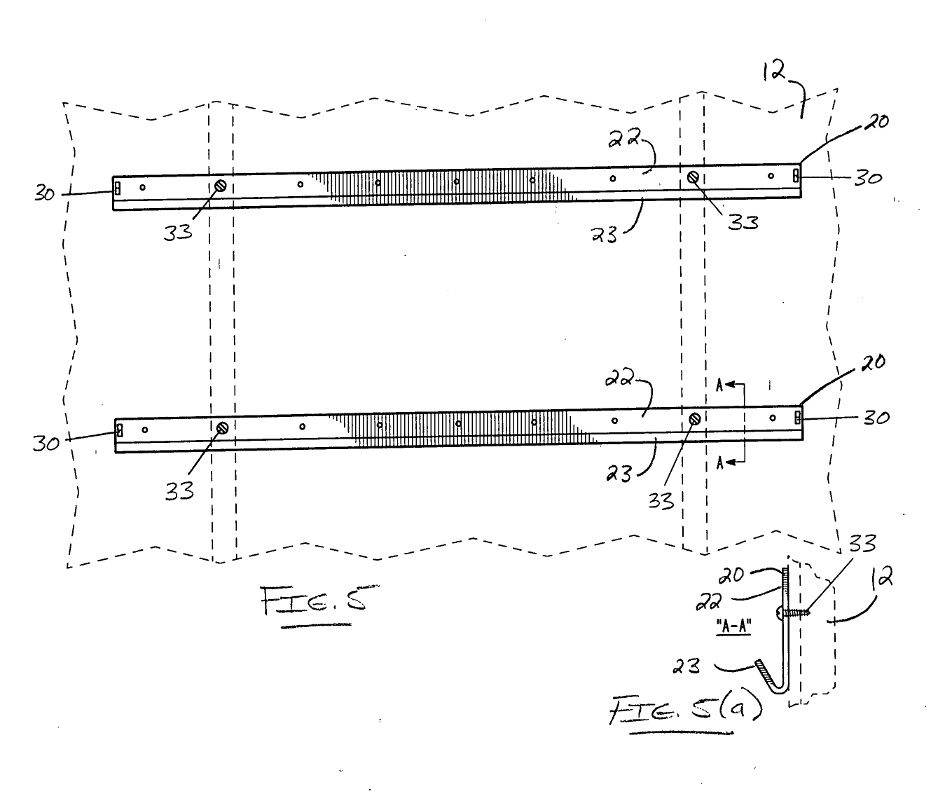

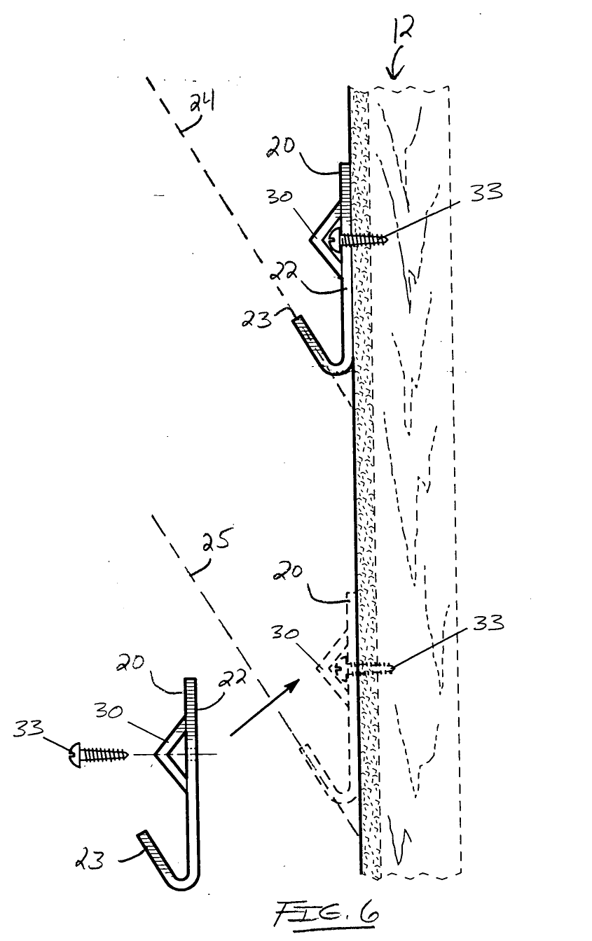

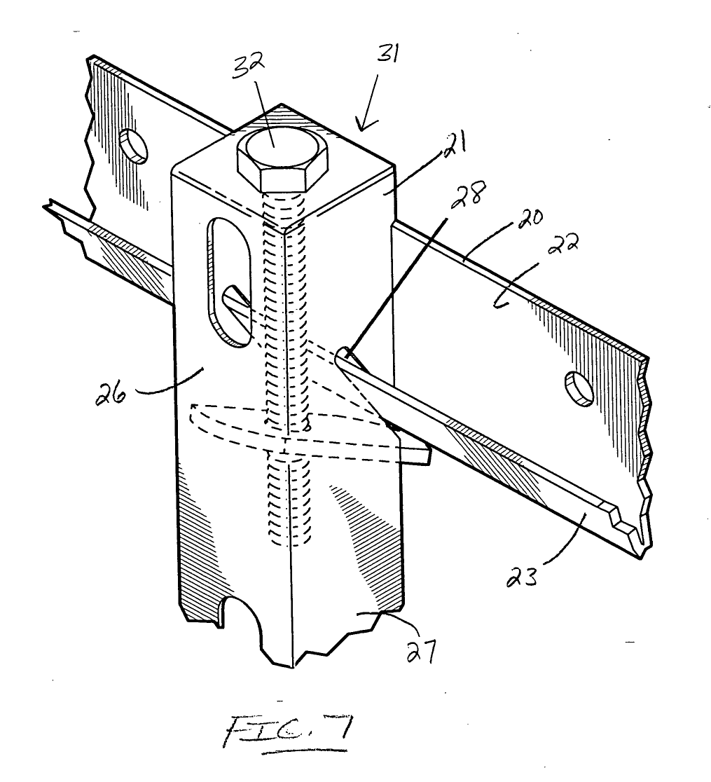

Referring now to the drawings, the preferred embodiment of the present invention concerns a bracketing assembly 10 primarily designed for mounting flat panel televisions 11 to vertical support structures 12 or walls, such as may be found in an entertainment room. Bracketing assembly 10 is illustrated and referenced in FIGS. 1 and 2; a generic flat panel television 11 is illustrated and referenced in phantom in FIGS. 1, 3, and 4; and a vertical support structure 12 is illustrated and referenced in phantom in FIGS. 5-6. It is thus contemplated that in one embodiment, the present invention discloses a television bracketing system for enabling (flat panel) television viewing adjacent a vertical support structure 12, the television bracketing system comprising, in combination, flat panel television 11 and bracket assembly 10. It will be seen from a comparative inspection of FIGS. 1, 3, and 4 that flat panel television 11 essentially comprises an anterior viewing surface 13 and a posterior television support surface 14.

The bracketing assembly 10 preferably comprises two support-mountable, groove-engageable bracket members 20 as illustrated and referenced in FIGS. 1, 2, and 5-7; and two television-mountable, grooved bracket members 21 as illustrated and referenced in FIGS. 1-4(a), and 7. Each support-mountable bracket member 20 comprises a planar support-mountable portion 22 and a planar groove-engageable portion 23 as illustrated and referenced in FIGS. 2 and 5-7. From an inspection of the noted figures, it will be understood that each support-mountable bracket member 20 comprises a substantially V-shaped transverse cross-section. The groove-engageable portions 23 are angled from support-mountable portions 22, preferably at an angle of 32° for maximizing support strength and for minimizing torque about the vertex.

The support-mountable portions 22 may be vertically juxtaposed adjacent the vertical support structure 11 and mounted thereto (via certain bracket mounting means, such as screws 33) in parallel relation to one another to form a bracketed support assembly. In other words, the vertical support structure 12 with mounted support-mountable portions 20 together form the bracketed support assembly. The groove-engageable portions 23 are thus angled from the support-mountable portions 22 at the inferior ends thereof and extend upwardly away from the vertical support structure 11 thus forming an upper support plane 24 and a lower support plane 25 as referenced in FIG. 6.

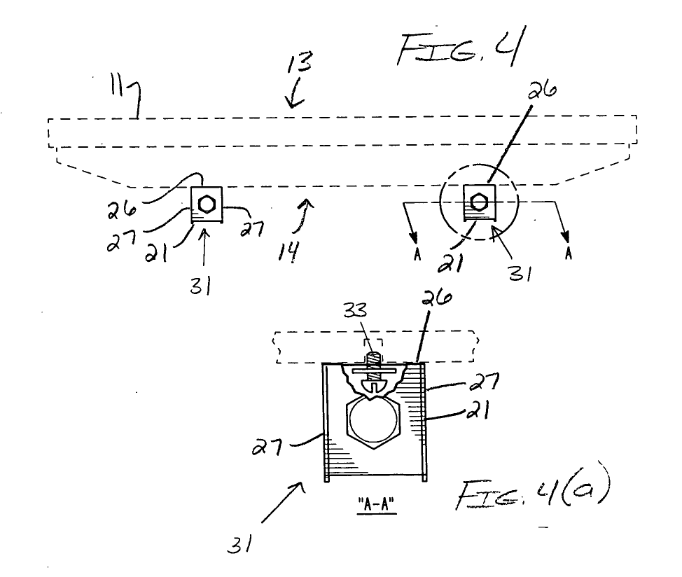

The television-mountable bracket members 21 each preferably comprise a planar television-mountable portion 26 as illustrated and referenced in FIGS. 3(a)-4(a), and 7; and two parallel planar support portions 27 as illustrated and referenced I FIG. 2-4(a), and 7. Notably, the support portions 27 are each preferably orthogonal to the television-mountable portion 26 of each bracket member 21, thus forming a substantially II-shaped transverse cross-section. Each support portion 27 further preferably comprises a first support groove 28 as depicted and referenced in FIGS. 2 and 7; and a second support groove 29 as depicted and referenced in FIG. 2.

The television-mountable portions 26 may thus be juxtaposed adjacent the television support surface 14 and mounted thereto (via certain bracket mounting means) in parallel relation to one another to form a bracketed television assembly. In other words, the television-mountable bracket members 21, together with the flat panel television 11, form a bracketed television assembly. Notably, the first support grooves 28 are preferably coplanar with one another and the second support grooves 29 are coplanar with one another and both sets of grooves are angled from the television-mountable portions 26 extending away from the television support surface 14.

The bracketed television assembly may thus be vertically juxtaposed adjacent the bracketed support assembly so as to align the upper support plane 24 with the coplanar first support grooves 28 and further to align the lower support plane 25 with the coplanar second support grooves 29 (the first support grooves 28 being parallel with the second support grooves 29). Thus, upper support plane 24 may be received in the first support grooves 28 and the lower support plane 25 may be received in the second support grooves 29 simultaneously. The bracketed support assembly thus supports the bracketed television assembly by way of the groove-engageable portions 23 and first and second grooves 28 and 29, respectively. The contemplated television bracketing system thus enables (flat panel) television viewing adjacent the vertical support surface 111 via the anterior viewing surface 13.

The support-mountable portions 22 inherently have opposing first and second support ends, each of which preferably comprises certain end stop structure 30 as illustrated and referenced in FIGS. 1, 5, and 6. The end stop structures 30 or end stops extend outwardly from the support-mountable portions 22 at the first and second support ends for preventing disengagement of the bracketed television assembly from the bracketed support assembly. In other words, it is contemplated that end stops 30 function to prevent the otherwise laterally slidable bracketed television assembly from sliding off the ends of bracket members 20. Thus, the support-mountable portions 22 preferably comprise end stops 30, which extend outwardly from the support-mountable portions 22 laterally adjacent the television-mountable bracket members 21 thus providing certain mechanical stop structure and preventing lateral displacement of the bracketed television assembly relative to the bracketed support assembly.

The television-mountable bracket members 21 inherently have opposing inferior and superior member ends. Superior member end(s) have been illustrated and referenced at 31 in FIGS. 2, 3, 4, 4(a), and 7. It will be seen from a comparative inspection of FIGS. 2 and 7 that the first support grooves 28 extend away the superior member ends 31, the upper support plane 24 thereby extending therethrough or extending in adjacency thereby. To further prevent displacement of the bracketed television assembly relative to the bracketed support assembly, it is contemplated that the bracketing system of the present invention may further comprise certain end-fastening means, the end-fastening means for securing the superior member ends 31 to the groove-engageable portion 23 of the upper support plane 24.

FIG. 7 depicts a certain preferred end-fastening means shown in hidden broken lines. In this regard, it will be seen that a bolt assembly 32 may be cooperatively associated with the superior member ends 31 and groove-engageable portion 23 of the upper support plane 24 as a means to further secure the bracketed television assembly to the bracketed support assembly. Notably, the end-fastening means preferably extend intermediate the support portions 27, which support portions 27 further function to mask the end-fastening means from view.

From an inspection of FIGS. 1, 3, 4, and 5, it will be seen that the anterior viewing surface 13 (of the flat panel television 11) has a certain viewing height and a viewing width. The television-mountable bracket members 21 preferably have a uniform television bracket length extending intermediate the inferior and superior member ends and the support-mountable bracket members 20 preferably have a uniform support bracket length extending intermediate the first and second support ends. The television bracket length(s) are preferably lesser in magnitude than the viewing height as generally depicted in FIGS. 1 and 3; and the support bracket length(s) are preferably lesser in magnitude than the viewing width as generally depicted in FIGS. 1 and 5. Thus, the anterior viewing surface 13 may be said mask the bracket assembly 10 when the anterior viewing surface is viewed from an anterior vantage point.

While the above description contains much specificity, this specificity should not be construed as limitations on the scope of the invention, but rather as an exemplification of the invention. For example, as is described hereinabove, it is contemplated that the present invention essentially discloses a bracketing assembly for positioning a first vertical support structure (for example, either posterior television support surface 14 or vertical support structure 12) relative to a second vertical support structure (for example, either vertical support structure 12 or posterior television support surface 14). The bracketing assembly comprising at least one, but preferably two or more, groove-engageable bracket members 20 and at least one, but preferably two or more grooved bracket members 21.

Each groove-engageable bracket member 20 comprises a first support-mountable portion such as portion 22, and a groove-engageable portion such as portion 23. The longitudinal axis of each first support-mountable portion is horizontally mounted to a first vertical support for forming a horizontally-aligned bracket assembly. Each groove-engageable portion is preferably angled from each first support-mountable portion, extending away from the first support structure.

Each grooved bracket member comprising a second support-mountable portion such as portion 26 and a grooved portion such as portions 27, each of which comprises at least one support groove. The longitudinal axis of each second support-mountable portion is preferably vertically mounted to a second vertical support for forming a vertically-aligned bracket assembly. Each grooved portion is preferably angled from each second support-mountable portion, extending away from the second support structure. The groove-engageable portion or portions are thus received and weight-retained in a select support groove. In other words, when mated, the grove-engageable portions and the grooves function to movement therebetween and the weight of the received assembly retains the bracketed assemblies in relatively fixed placement. The horizontally-aligned and vertically-aligned bracket assemblies thus cooperatively position the first vertical support relative to the second vertical support by way of each groove-engageable portion and support groove. The bracketing assembly of the present invention thus functions to position the first vertical support relative to the second vertical support.

As noted, the bracketing assembly preferably comprises at least two groove-engageable bracket members and at least two grooved bracket members. In this regard, it should be further noted that the grooved bracket members each preferably comprise at least two vertically spaced support grooves. The groove-engageable bracket members are preferably mounted in parallel relation to one another and the grooved bracket members are preferably mounted in parallel relation to one another. The groove-engageable and grooved bracket members thus form at least one rectangular bracket assembly for maintaining the first vertical support in positioned placement relative to the second vertical support. In other words, the longitudinal axes of the bracket members 20 and 21, when in mounted and mated engagement, form the boundaries of a rectangular configuration, which configuration functions to maintain the first vertical support in positioned placement relative to the second vertical support.

Certain bracket displacement-preventing means are further contemplated and may be defined by end stops 30 or bolt assembly 32 or a combination of similar other mechanical stop structures designed to prevent displacement of each select support groove relative to each groove-engageable portion. In other words, certain lateral displacement-preventing means are contemplated as may be defined by end stops 30 or the end-fastening means, for preventing lateral displacement of each second support-mountable portion relative to each first support-mountable portion. Further, certain longitudinal displacement-preventing means as may be defined by the end-fastening means may function to prevent longitudinal displacement of each second support-mountable portion relative to each first support-mountable portion.

Furthermore, the invention contemplates a certain method for positioning a first vertical support structure relative to a second vertical support structure, the method comprising the steps of: angling at least one laterally-extending, planar groove plate (such as groove-engageable portion 23) away from at least one first bracket (such as first support-mountable portion 22); attaching each first bracket to a first vertical support (such as vertical support structure 12); angling laterally-spaced, coplanar plate-receiving grooves (such as grooves 28 and 29) away from at least one second bracket (such as second support-mountable portion 26; attaching each second bracket to a second vertical support (such as posterior television support surface 14); inserting each groove plate into the plate-receiving grooves; and weight-retaining the groove plate in the plate-receiving grooves, thereby positioning the first vertical support relative to a second vertical support.

The method may further involve the step(s) of angling at least two groove plates away from at least one first bracket and angling at least two sets of plate-receiving grooves away from at least one second bracket, the two groove plates thereby extending in parallel plate planes, and the two sets of plate-receiving grooves extending in parallel groove planes. Further, at least one second bracket may be fastened to the first bracket after weight-retaining the groove plate in the plate-receiving grooves, as for example when the superior member ends 31 are fastened to the groove plate or groove-engageable portion 23 of the upper support plane 24. Still further, at least one second bracket may be laterally restrained after weigh-retaining the groove plate in the plate-receiving grooves, as for example, when end stops 30 or the end-fastening means prevent lateral displacement of the weight (downwardly acting force)-retained assembly.

Accordingly, although the invention has been described by reference to certain preferred embodiments and methodology, it is not intended that the novel disclosures herein presented be limited thereby, but that modifications thereof are intended to be included as falling within the broad scope and spirit of the foregoing disclosure, the following claims and the appended drawings.

We claim:

1. A television bracketing system for enabling television viewing adjacent a vertical support structure, the television bracketing system comprising, in combination, a flat panel television and a bracket assembly, the flat panel television comprising an anterior viewing-surface and a posterior support surface, the bracketing assembly comprising two support-mountable bracket members and two television-mountable bracket members, each support-mountable bracket member comprising a planar support-mountable portion and a planar groove-engageable portion, the support-mountable portions being vertically juxtaposed adjacent the vertical support structure and mounted thereto in parallel relation to one another thus forming a bracketed support assembly, the groove-engageable portions being angled from the support-mountable portions at the inferior ends thereof and extending upwardly away from the vertical support structure thus forming an upper support plane and a lower support plane, the television-mountable bracket members each comprising a planar television-mountable portion and two parallel planar support portions, the support portions each being orthogonal to the television-mountable portion and comprising first and second support grooves, the television-mountable portions being juxtaposed adjacent the television support surface and mounted thereto in parallel relation to one another thus forming a bracketed television assembly, the first support grooves being coplanar and the second support grooves being coplanar, the first and second support grooves being angled from the television-mountable portions and extending away from the television support surface, the bracketed television assembly being vertically juxtaposed adjacent the adjacent the bracketed support assembly, the upper support plane being received in the first support grooves and the lower support plane being received in the second support grooves simultaneously, the bracketed support assembly thus supporting the bracketed television assembly by way of the groove-engageable portions and first and second grooves, the flat panel television bracketing system thus enabling television viewing adjacent the vertical support surface via the viewing surface.

2. The bracketing system of claim 1 wherein the support-mountable portions each comprise end stops, the end stops extending outwardly from the support-mountable portions laterally adjacent the television-mountable bracket members thereby preventing lateral displacement of the bracketed television assembly relative to the bracketed support assembly.

3. The bracketing system of claim 1 wherein the support-mountable portions have first and second support ends, the first and second support ends each comprising end stops, the end stops extending outwardly from the support-mountable portions at the first and second support ends preventing disengagement of the bracketed television assembly from the bracketed support assembly.

4. The bracketing system of claim 1 comprising end-fastening means, the television-mountable bracket members each having superior member ends, the end-fastening means for securing the superior member ends to the groove-engageable portion of the upper support plane.

5. The bracketing system of claim 4 wherein the end-fastening means extend intermediate the support portions, the support portions for masking the end-fastening means from view.

6. The bracketing system of claim 1 wherein the anterior viewing surface has a viewing height and a viewing width, the television-mountable bracket members have a uniform television bracket length, and the support-mountable bracket members have a uniform support bracket length, the television bracket length being lesser in magnitude than the viewing height, and the support bracket length being lesser in magnitude than the viewing width, the anterior viewing surface thus for masking the bracket assembly when viewed from an anterior vantage point.

7. A bracketing assembly for positioning a first vertical support structure relative to a second vertical support structure, the bracketing assembly comprising at least one groove-engageable bracket member and at least one grooved bracket member, each groove-engageable bracket member comprising a first support-mountable portion and a groove-engageable portion, each first support-mountable portion being horizontally mounted to a first vertical support for forming a horizontally-aligned bracket assembly, each groove-engageable portion being angled from each first support-mountable portion and extending away from the first support structure, each grooved bracket member comprising a second support-mountable portion and a grooved portion, each grooved portion comprising at least one support groove, each second support-mountable portion being vertically mounted to a second vertical support for forming a vertically-aligned bracket assembly, each grooved portion being angled from each second support-mountable portion and extending away from the second support structure, each groove-engageable portion being received and weight-retained in a select support groove, the horizontally-aligned and vertically-aligned bracket assemblies thus cooperatively positioning the first vertical support relative to the second vertical support by way of each groove-engageable portion and support groove, the bracketing assembly thus for positioning the first vertical support relative to the second vertical support.

8. The bracketing assembly of claim 7 comprising at least two groove-engageable bracket members and at least two grooved bracket members, the grooved bracket members each having at least two vertically spaced support grooves, the groove-engageable bracket members being parallel to one another and the grooved bracket members being parallel to one another, the groove-engageable and grooved bracket members thus forming at least one rectangular bracket assembly for maintaining the first vertical support in positioned placement relative to the second vertical support.

9. The bracketing assembly of claim 7 wherein each first support-mountable portion comprises end stops, the end stops extending outwardly from each support-mountable portion laterally adjacent each grooved bracket member for preventing lateral displacement of the vertically-aligned bracket assembly.

10. The bracketing assembly of claim 7 wherein each first support-mountable portion has first and second support ends, the first and second support ends each comprising end stops, the end stops extending outwardly from the support-mountable portions at the first and second support ends for maintaining each groove-engageable portion in the select support groove.

11. The bracketing assembly of claim 7 wherein each second support-mountable portion has a superior member end, the select support groove extending away the superior member end.

12. The bracketing assembly of claim 11 comprising end-fastening means, the end-fastening means for fastening each superior member end to a superior groove-engageable bracket member.

13. The bracketing assembly of claim 12 wherein the end-fastening means extend intermediate the second support-mountable portions, the second support-mountable portions for masking the end-fastening means from view.

14. The bracketing assembly of claim 7 comprising displacement-preventing means, the displacement-preventing means for preventing displacement of each select support groove relative to each groove-engageable portion.

15. The bracketing assembly of claim 7 comprising lateral displacement-preventing means, the lateral displacement-preventing means for preventing lateral displacement of each second support-mountable portion relative to each first support-mountable portion.

16. The bracketing assembly of claim 7 comprising longitudinal displacement-preventing means, the longitudinal displacement-preventing means for preventing longitudinal displacement of each second support-mountable portion relative to each first support-mountable portion.

17. A method for positioning a first vertical support structure relative to a second vertical support structure, the method comprising the steps of:
angling at least one laterally-extending, planar groove plate away from at least one first bracket;
attaching each first bracket to a first vertical support;
angling laterally-spaced, coplanar plate-receiving grooves away from at least one second bracket;
attaching each second bracket to a second vertical support;
inserting each groove plate into the plate-receiving grooves; and
weight-retaining the groove plate in the plate-receiving grooves, thereby positioning the first vertical support relative to a second vertical support.

18. The method of claim 17 wherein at least two groove plates are angled away from at least one first bracket and at least two sets of plate-receiving grooves are angled away from at least one second bracket, the two groove plates extending in parallel plate planes, the two sets of plate-receiving grooves extending in parallel groove planes.

19. The method of claim 17 wherein at least one second bracket is fastened to the first bracket after weight-retaining the groove plate in the plate-receiving grooves.

20. The method of claim 17 wherein at least one second bracket is laterally restrained after weigh-retaining the groove plate in the plate-receiving grooves.
